(19) United States
(12) Patent Application Publication
(10) Pub. No.: US 2002/0018822 A1
(43) Pub. Date: Feb. 14, 2002

(54) Air cooling ring for blown plastics film

(76) Inventor: Robert D. Krycki, Brampton (CA)

Correspondence Address: Thomas R. Vigil, c/o Vigil & Associates, 836 South Northwest Highway, Barrington, IL, 60010, US

(21) Appl. No.: 09/751,211

(22) Filed: Dec. 29, 2000

(30) Foreign Application Priority Data
Aug. 9, 2000 (CA) 2,315,463

(51) Int. Cl. B29C 47/88

(52) U.S. Cl. 425/72.1; 425/378.1

(57) ABSTRACT

An air ring, for supplying successive streams of cooling air to the exterior surface of a tubular bubble of plastic after its extrusion from an annular die, has a primary annular cooling air outlet arranged to be located around and closely adjacent the die orifice, and a secondary annular cooling air outlet located axially downstream of the primary annular air outlet in the direction of travel of the tubular bubble. The primary annular air outlet is formed between an inner lip and an adjacent edge of an intermediate lip, and the secondary annular air outlet is formed between an outer lip and an adjacent edge of the intermediate lip, The lower lip, intermediate lip, and the outer lip are arranged to diverge from the die so as to allow the tubular bubble to expand coaxially with the die at an angle of divergence of at least 60 degrees from the die axis without interfering with any of the lips. Air ring means is also provided for ease of adjustment of cooling air flow rate from the primary cooling outlet. Better control of the product is therefore made possible while permitting tubular bubble expansion with an angle of divergence of up to 60 degrees or more. Apparatus is also included to remove contaminants from a tubular bubble immediately after its extrusion.

### BACKGROUND OF THE INVENTION

1. Field of the Invention

The present invention relates to the plastics industry in general and in particular to apparatus for extruding blown film. More particularly, it relates to an air cooling ring for supplying air to cool a plastic tubular bubble as it leaves an extrusion die.

2. Related Art

All blown film is extruded either vertically, up or down, or horizontally. In all instances, as the polymeric material exits the cylindrical die as a tube, air is passed through the die into the tube to inflate the tube to form a tubular bubble, the passage of air being controlled to provide the bubble with a desired diameter. In addition, as the tube leaves the die, it is cooled by the air blown from an annular nozzle or nozzles provided in an air cooling ring or so called “air-ring”.

The ring is connected to an air plenum chamber which supplies large quantities of air to the outside of the bubble so that it becomes firm before it passes between two rollers (usually known as “nip rollers”) of a tube collapsing system downstream in the direction of movement of the tube from the die. The nip rollers collapse the bubble at its downstream end.

Hitherto, the angle of divergence at which the bubble expands as it leaves the die orifice has been limited to less that 30 degrees with respect to the die axis, and is usually about 20 degrees. Unless the bubble can continue to expand markedly after the bubble is clear of the cooling air, this limits the maximum diameter of the bubble. A typical prior art air ring is shown, for example, in U.S. Pat. No. 4,750,874, issued Jun. 14, 1998 to Keim, which shows an air ring having a first annular air outlet formed between a lower or inner lip and the adjacent end of an intermediate lip, and a second air outlet, downstream from the first outlet in the direction of travel of the bubble, formed between an upper or outer end of the intermediate lip and an outer lip. The inner and outer lips are arranged so that the bubble cannot expand at an angle of divergence of more than 28 or 30 degrees to the die axis as it leaves the die. It seems to have been accepted in the industry that an angle of divergence of the bubble of more than about 30 degrees cannot be achieved.

Further to this, during operation of the apparatus to make blown film, and for any given polymeric material, the blow up ratio and rate of change in film thickness of the tubular bubble are at least partly dependent upon the flow rate of cooling air directed on to the tubular bubble immediately after it leaves the die orifice. The blow up ratio is considered to be the ratio of the final expanded diameter of the tubular bubble to the tube diameter as it issues from the die orifice. To adjust these parameters it may be necessary to adjust the flow rate of cooling air through an annular nozzle which lies closely adjacent to the die orifice. Adjustment of the cooling air flow rate is known to be a fine tuning operation to produce a required blow up ratio and film thickness suitable for a particular polymer. Conventionally, the adjustment requires an operator to reach into the radically central regions of the air cooling ring to make mechanical adjustments. This operation must be done with extreme care and precision and is delicate to perform thereby requiring utmost operator skill. The difficulties in skill required and time taken to make the adjustments are increased where a cooling ring includes a plurality of axially spaced nozzles and, in such arrangements, the nozzle which requires adjustment is the radially inner or the innermost of these nozzles. It would be a desirable improvement to enable the operator to adjust the cooling air flow rate of this nozzle in a more convenient manner and during operation of the apparatus.

In addition, the tube of polymeric material, upon issue from an extrusion die orifice, is accompanied by undesirable contaminants, such as smoke, odorous fumes and other airborne contaminants resulting from the extrusion process. These contaminants serve to increase pollution of the atmosphere immediately within the working environment adjacent to the extrusion apparatus and progressively pass into and pollute the surrounding atmosphere within a factory. Hence, such contaminants present an uncomfortable and possibly unhealthy atmosphere in which to work. It would desirous, therefore, if some means were to be found for at least reducing contaminant infiltration into the atmosphere.

### SUMMARY OF THE INVENTION

The present invention seeks to provide apparatus which is improvement upon conventional constructions and at least minimizes the problems discussed above.

According to one aspect of the invention, an air ring means for supplying successive streams of cooling air to the exterior surface of a tubular bubble of plastic, after its extrusion from an annular die orifice, is similar to that of the ′874 Patent in that it comprises:

a ring shaped plenum chamber having an air inlet means, a primary annular air outlet arranged to be located around and closely adjacent to the die and communicating with the plenum chamber,

A secondary annular air outlet located axially downstream of the primary annular air outlet in the direction of travel of the bubble, and also communicating with the plenum, chamber,

the primary annular air outlet being formed between inner lip means and an edge of an intermediate lip means adjacent the inner lip means, and the secondary annular air outlet being formed between an outer lip means and an adjacent edge of the intermediate lip means.

This aspect of the present invention differs from the above prior art in that the inner lip means, the intermediate lip means and the outer lip means provide a clear space allowing the tubular bubble to expand from the die at an angle of divergence, measured from the die axis, of approximately 60 degrees or more.

The intermediate lip means preferably has a substantially conical inner surface which diverges from the inner lip means at an angle to the die axis which is at least as great as the aforementioned angle of divergence.

The cross-sectional area of the secondary annular air outlet is preferably several times greater than the cross-sectional area of the primary air outlet.

According to a further aspect of the present invention, an air ring means having a primary and secondary annular air outlets is provided with an air flow control means which is rotatably adjustable in position around the die axis. The air flow control means comprises a ported ring which has a plurality of ports for air flow passages which allow for air flow from the plenum chamber to the primary annular air outlet. Rotational adjustment of the ported ring in a desired direction causes movement of the ports relative to the air flow passages so as to appropriately adjust the effective area for air flow through the passages and thus the rate of air flow from the primary annular air outlet. In this further aspect of the present invention, means is also provided to adjust the rotational position of the air flow control means, the adjustment means operably connected to the ported ring and being operationally accessible exteriorly of the air ring means.

Constructions according to the further aspect of the invention discussed above enable the rate of air flow to the primary annular air outlet to be easily adjusted during operation of the extruder die, i.e. while plastics material is being extruded to form a plastic tubular bubble which is being continuously fed towards the nip rollers. The rate of cooling, rate of reduction in film thickness during radial expansion of the bubble, and blow up ratio, are more easily controllable during extrusion and bubble forming than has been possible previously. The ease of control of the rate of cooling air flow enables the primary and secondary cooling air outlets to be designed to allow the tubular bubble to expand from the die orifice at an angle of divergence from the die axis of at least 45 degrees and up to 60 degrees or more without detrimentally affecting the product during its formation.

The ported ring position may also control, if required, the flow of air to the secondary annular air outlet of the ring means. However, under normal circumstances control of the rate of air flow is only required for the primary annular air outlet.

It is convenient for the air flow control means to be located radially outwardly of the die axis from the air flow passages which are provided for air flow to the primary annular air outlet. This enables the adjustment means to be disposed a maximum distance away from the extruder die and thus more accessible for manual operation if this is to be used. Alternatively, the adjustment means may be operated by powered means such as electric power under the control of an operator, or, for instance, as controlled from a feedback mechanism having a downstream sensor measuring the thickness of the wall of the finished tubular bubble.

The adjustment means preferably comprises a driving gear engaged with a driven gear provided upon the ported ring, the driving gear being rotatably mounted about a fixed axis upon a driving shaft which extends to the exterior of a wall of the air flow control means for operating purposes.

It is also convenient for an indicator means to be provided at the exterior end of the driving shaft to indicate, at any particular position of rotation shaft, the amount of effective areas for air flow through the air flow passages that is provided with the shaft in the corresponding rotational position.

The invention also provides, according to yet a further aspect, an apparatus for extruding a tubular bubble of plastic comprising:

a plastics extruder having an annular die orifice surrounding a die axis;

air ring means for supplying cooling air to the exterior surface of the tubular bubble of plastic after its extrusion from the die orifice, the air ring means comprising:

a ring shaped plenum chamber radially outwardly of the die axis from the die orifice and having cooling air inlet means; and

annular cooling air outlet means interconnected to the plenum chamber closely adjacent to the die orifice to cause the tubular bubble to expand radially in coaxial manner relative to the die axis as it moves downstream from the die orifice; and

an air filtering device, the air filtering device providing an annular air inlet orifice disposed axially between the die orifice and the annular cooling air outlet means so as to face towards the exterior of the tubular bubble as it is being formed, the inlet orifice inter-connectable to vacuum creating means for removing contaminants from the exterior of the tubular bubble.

With the use of apparatus according to the invention defined immediately above, a significant percentage of contaminants, such as smoke, odorous fumes and other airborne contaminants resulting from the extrusion process, are removed by a vacuum process immediately bubble emerges from the die orifice.

The apparatus preferably has an annular chamber of the filtering device, the annular chamber being connected to the inlet orifice by air passage means which is preferably a disc-shaped passage.

### BRIEF DESCRIPTION OF THE DRAWINGS

Embodiments of the invention will now be described, by way of example, with reference to the accompanying drawings in which:

FIG. 1 is a sectional elevation through an air ring means according to a first embodiment for plastic film and in association with an extrusion die;

FIG. 2 is an enlarged view of a portion of FIG. 1 and showing air outlets;

FIGS. 3 and 4 are views similar to FIG. 2 of air ring means according to second and third embodiments;

FIG. 5 is an enlarged view of a portion of FIG. 4 to show detail of third embodiment;

FIGS. 6 and 7 are views of a ported ring in the direction of arrow VI-VI in FIG. 5 and which is apart of an air ring means of the third embodiment;

FIGS. 8 and 9 are views in the direction of arrow VIII in FIG. 5 of another part of the air ring means of the third embodiment showing different positions of indicator means corresponding, respectively, to positions of an air flow control means shown in FIG. 6 and 7; and

FIG. 10 is a view similar to FIG. 2 of a fourth embodiment.

### DETAILED DESCRIPTION OF THE PREFERRED EMBODIMENTS

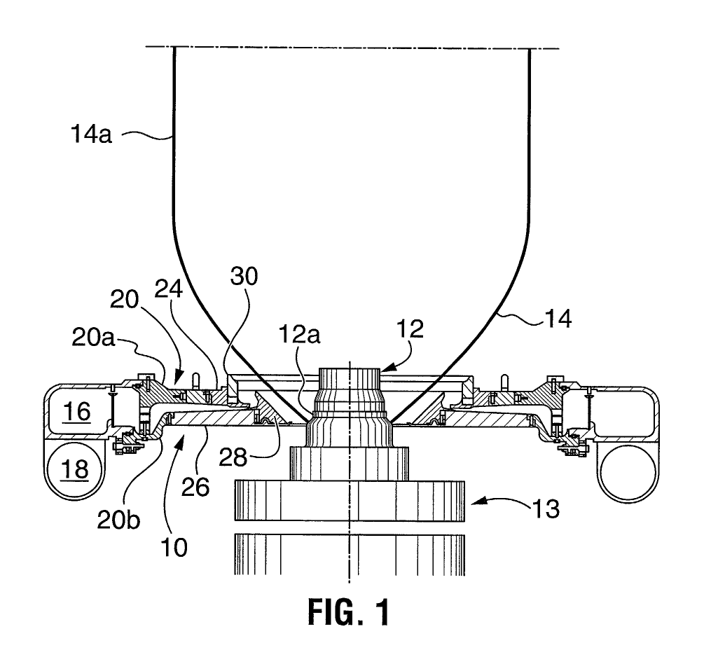

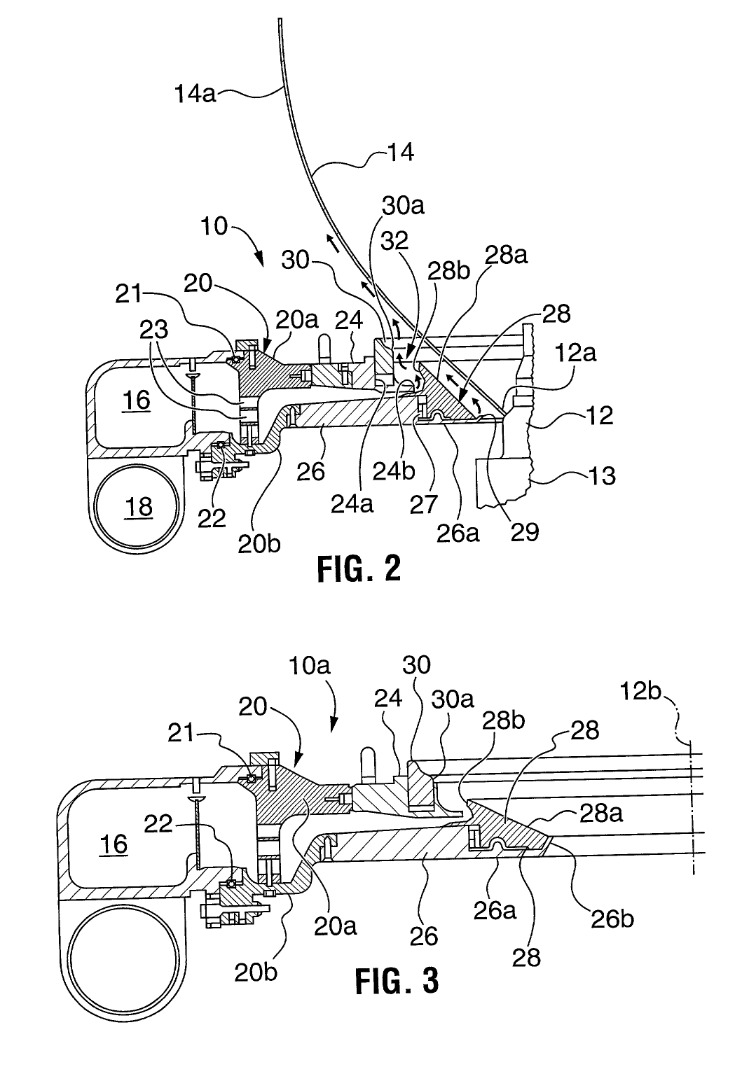

FIGS. 1 and 2 show an air ring means, generally indicated as item 10, in its operative position surrounding an extrusion die mounted on top of a plastics extruder indicated at 13 and having a die aperture in an annular nozzle 12a on an outwardly/upwardly facing shoulder set at about 45 degrees to the axis 13a of the extruder die. The nozzle produces a thin-walled cone of plastic, i.e. polymeric material, which is expanded to form an expanding tubular bubble 14 by air injected into the tube through the centre of the nozzle 12a, while the bubble is drawn upwards by nip rollers (not shown). The nozzle, central air supply and cooling can are all of known form and do not constitute part of the invention.

The air ring means 10 is surrounded by an air plenum chamber 16 supplied with air through inlet ducts 18. An annular connecting member 20 has seals 21, 22, connecting it to upper and lower walls of the plenum chamber while allowing rotation of the air ring means, this rotation being provided in known manner. The member 20 has upper and lower flanges 20a and 20b by which it is connected respectively to an outer lip holder 24, and an inner lip part 26. Passages 23 through the connecting member allow air to pass from the chamber 16 to the space between the flanges 20a and 20b. The inner lip part 26 has a thin, radially inwardly extending inner lip 26a, which is spaced from the die 12 and situated just upstream of (just below) the die outlet nozzle 12a. The part 26 also supports, via a screw connection 27, and intermediate lip means 28, the lower edge of which is closely adjacent the inner lip 26a, to define therewith a narrow primary air outlet 29 which directs air generally inwards on to the die at or just below the nozzle 12a.

The intermediate lip means 28 has a conical inner face 28a set at an angle of divergence of about 45 degrees to the die axis 12b from the primary air outlet 29; in this arrangement the intermediate lip means is termed a “forming cone.” Its conical angle is at least as great as the angle at which the bubble 14 expands from the nozzle 12a so that this intermediate lip means cannot interfere with the bubble; as shown, the conical angle of surface 28a to the die axis is about 45 degrees.

The outer lip holder 24 has a recess 24a with inner and outer cylindrical walls between which is mounted a cylindrical annular member 30, termed an “adjustable chimney”; this is capable of being adjusted in axial position within the recess. An edge 30a of the member 30 adjacent the intermediate lip means 28 constitutes an outer lip means forming a secondary air outlet 32 with the intermediate lip means. This secondary outlet is more specifically defined between a generally cylindrical inner surface of the member 30 and an outwardly sloping surface 28b of the intermediate lip means 28. Thus, the air issuing from this outlet has a slightly divergent direction which helps to correctly direct the emerging bubble. The area of this secondary air outlet is much larger than that of the primary air outlet 29. The flow of air to the secondary outlet is restricted by an inwardly extending portion 24b of the outer lip holder which forms a constriction with an inner surface of the intermediate lip means 28.

In operation, air is supplied to the plenum chamber 16 while plastic is extruded from the nozzle 12a. The plastic leaves the nozzle as a cone with an angle of divergence of about 45 degrees from the die axis, and air issuing from the primary and secondary air outlets 29 and 32 both cools the plastic and ensures that it does not contact any of the lip means, which are well clear of plastic issuing with this angle of divergence. The plastic is drawn away from the nozzle 12a by the nip rollers. The wide angle of divergence allowed for by the lip means permits a large diameter bubble to be formed in limited space, i.e. in a limited axial direction. Thus, the expanding tube 14a is formed in a minimal axial direction from the extrusion die 12 to the nip rollers thereby enabling the axial distance of the nip rollers to the die also to be minimized.

In further embodiments now to be described, features of the embodiments similar to those of the first embodiment will be referred to using the same reference numbers.

FIG. 3 shows an air ring means 10a which is generally of similar construction to that of the first embodiment but in which an even wider angle of divergence for the tubular bubble is permitted. The lip means in the second embodiment are differently designed so as to allow an angle of divergence from the die axis 12b of up to 60 degrees. With this arrangement, the expanded bubble 14a is formed in an axial distance which is even less than in the first embodiment thereby enabling even greater reduction in the distance of the nip rollers from the extrusion die.

In the second embodiment, the inner lip means 26a, instead of being flat, has an inner end portion 26b sloped upwards at about 45 degrees to the die axis, to provide an outwards facing surface which defines, with the intermediate lip means 28, a primary air outlet producing a primary air flow which has an upwards as well as an inwards component. For this purpose, the lower inner surface of the intermediate lip means has a complementary downwardly and outwardly sloping surface spaced just inside the inner lip.

Secondly, the intermediate lip means 28 has its conical surface 28a lying at a conical angle such that the surface 28a extends at 60 degrees, instead of 45 degrees, to the die axis. Similarly, the outer lip means 30a is spaced further outwards from the adjacent edge of the intermediate lip means 28 than in the first embodiment to permit air to be directed at 60 degrees to the die axis from the directional guide of the conical surface 28a.

All of the above difference allow a bubble to expand from the die orifice at an angle of 60 degrees to the die axis 12b without interference from any of the lip means.

As is known in the art, the air ring means may be rotated so that the air leaving the outlet means has a rotating component; this is desirable in producing certain products.

As is also known, the plastic being extruded may be a plastic foam. It is usually preferred to extrude such foam horizontally rather than vertically as shown.

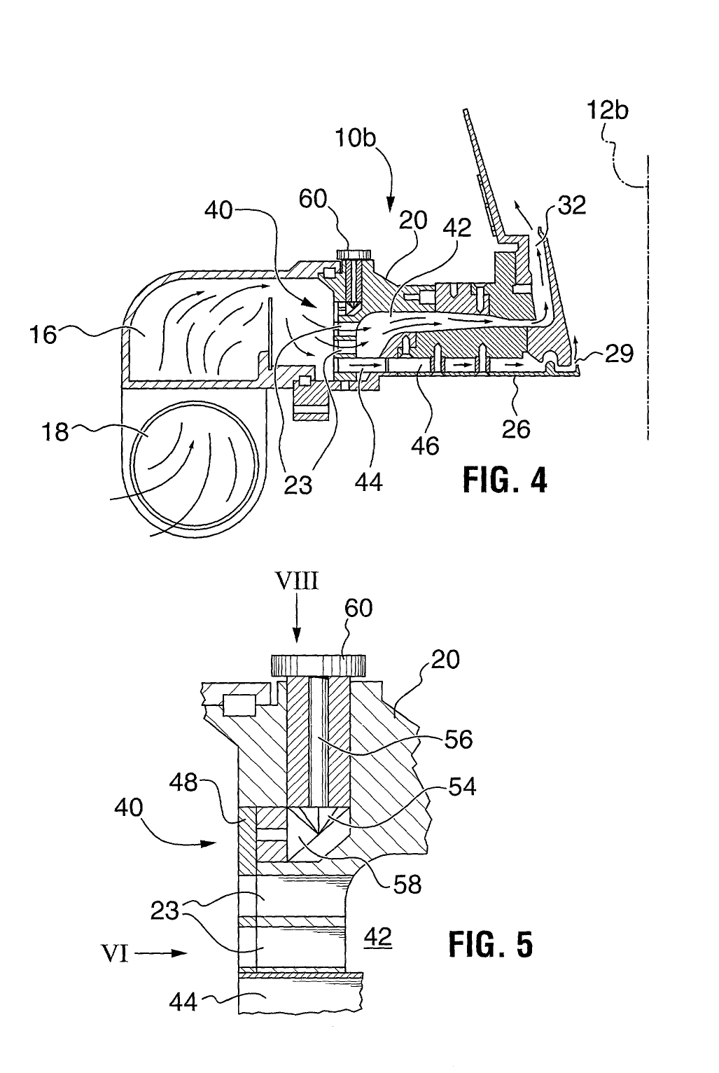

In a third embodiment an air ring means 10b as shown in FIG. 4, but particularly in FIG. 5, is provided with an air flow control means indicated generally at reference 40. In this construction, the connecting member 20 of the air ring means has air flow passages 23 which supply cooling air only to the secondary cooling air outlet 32 though interconnecting passages 42. Cooling air to the primary cooling air outlet 29 is supplied through cooling air flow passages 44 of the connecting member 20 by way of interconnecting passages 46 defined on one side by the inner lip part 26.

In this embodiment, the air flow control means 40 comprises a ported ring 48 which, as is more clearly shown by FIG. 5, is disposed radially outwards, with regard to the die axis, from the flow passages 23 and 44.

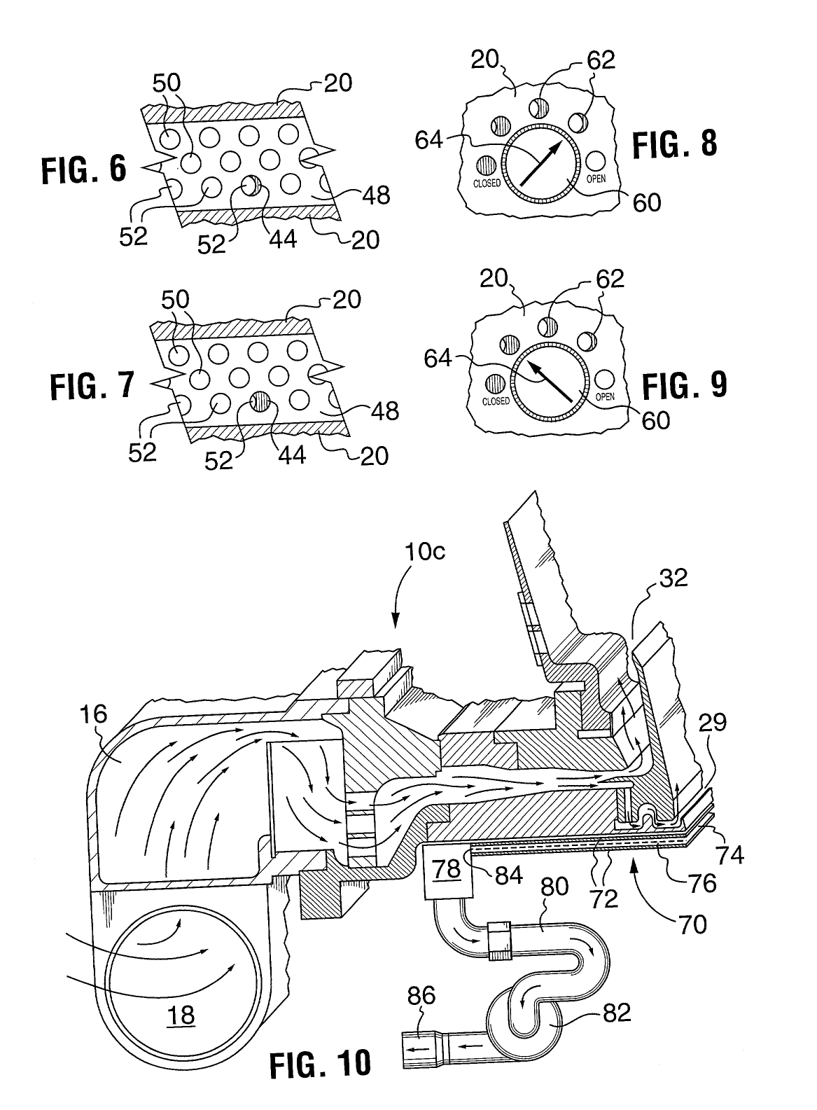

This ring has two horizontal layers of ports 50 (see particularly FIGS. 6 and 7) for alignment with the air flow passages 23 to enable air to flow through these passages to the secondary air outlet 32. In addition, the ring 48 has a single lower horizontally extending layer of ports 52 for alignment with the air flow passages 44. The ported ring 48 is rotatable around the die axis 12b for the purpose of varying the effective openings for air flow into and through the air flow passages 44 to the primary air outlet 29. The relative positions of the ports 52 and the passages 44 allow for change in coverage of the passages 44 so as to correspondingly vary the rate of air flow as the rotational position of the ring is changed. However, while the ring 48 is rotatable as discussed, the size and positions of the ports 50 relative to the air flow passages 23 are such that the ports 50 allow substantially the same rate of air flow through the passages 23 for any rotational position of the ring 48.

The ported ring 48 is provided with a position adjustment means for controlling its rotational position around the die axis as desired so as to vary the rate of air flow into and through the air flow passages 44. The adjustment means in this embodiment comprises a driving gear 54 which is rotatably mounted about a fixed axis upon a vertical rotatable driving shaft 56 mounted in the connecting member 20. The driving gear 54 is driveably in mesh with a driven gear 58 mounted upon an upper region of the ported ring 48. An upper end of the driving shaft 56 extends outwardly from the connecting member 20 and is provided with a manually operable knob 60.

As may be seen from FIGS. 6 and 7, the ported ring 48 may be rotated to any desired rotational position with the object of moving the ports 52 to vary the degree of opening of the inlet ends of the air flow passages 44 as desired. Thus, as shown by FIG. 6, with the ring 48 in one desired position each of the air flow passages 44 is substantially fully open (as shown by one air flow passage 44 in FIG. 6) so that the air flow rate through the air flow passages is almost maximized. In another rotational position of the ring 48, as shown by FIG. 7, the air flow passages 44 are allowed only a small opening with the ports 52 mainly closed by the connecting member 20. This provides a minimum desirable air flow rate through the air flow passages 44.

An indicator means is provided in this embodiment to indicate at any particular position of rotation of the shaft 56, the corresponding amount of the effective area for air flow through the air flow passages 44. This indicator means comprises an array of circular symbols 62 provided upon the outer surface of the connecting member 20 and extending around the operating knob 60. As shown by FIGS. 8 and 9, these symbols are progressively shaded from one end to the other of the array to correspond to the different effective openings of the air flow passages 44 dependent upon the different angular positions of the ring 48. An indicator arrow 64 provided upon the upper surface of the operating knob 60 points towards a particular symbol 62 or between symbols to indicate the actual effective openings of the passages 44 at any particular time. Thus, as the examples in FIGS. 8 and 9 show, the arrows in these Figures show respectively the degree of openings of the passages 44 in each of FIGS. 6 and 7.

As may be seen, in the use of the apparatus of the third embodiment, the rate of cooling air flow to the primary annular air outlet 29 is easily changed and controlled during operation. This is because of the use of the air flow control means as described. The use of the ported ring 48, simply by manual or automatic rotation, controls the rate of air flow to the outlet 29 while the tubular bubble is being extruded and formed into its largest diameter before moving between the nip rollers (not shown). Further to this, because the ring lies radially outwards from the air flow passages 44, the manual or automatic operation, i.e. the knob 60, is disposed a substantial distance from the extruder and also from the tubular bubble during its formation. Therefore, the knob is easily accessible for adjustment purposes with minimal risk of contacting the bubble.

The third embodiment provides the facility to change the rate of air flow to the primary annular air outlet 29 without affecting the rate of flow to the secondary outlet 32. This enables the cooling effect upon the tubular bubble at the commencement of its formation to be fine tuned. This rate of air flow adjustment is available to suit any specific polymer which is being extruded and expanded to provide a required blow up ratio and film thickness. The rate of cooling, rate of reduction in film thickness during radial expansion of the bubble and blow up ratio is thus easily controllable during actual operation. In a situation where a sensor is used in a downstream position, for instance to measure finished material thickness, this thickness may be adjusted as desired simply by manual operation.

The ease of control of the air flow rate enables the primary and secondary cooling air outlets to be designed to allow for the tubular bubble to expand from the die orifice at an angle of divergence of at least 45 degrees from the die axis 12b without detrimentally affecting the product during its formation. The angle of diversion may even extend up to 50 or 60 degrees, or even greater. Thus, the air flow control means is applicable for use with a relatively small angle of divergence as in FIG. 4 and also with larger divergence angles up to and above 60 degrees as shown in FIGS. 1 to

The third embodiment is thus of importance where adjustment is required without closing down the line or interrupting the standard production methods. This embodiment lends itself very favourably to automation with the ported ring air flow controlled remotely.

In a fourth embodiment, as shown by FIG. 10, a cooling air ring means 10c is provided with an air filtering device 70. This air filtering device has two horizontal plates 72 which extend from an annular orifice 74 surrounding the die axis, the plates being spaced apart to provide an annular vacuum passageway 76 extending from the orifice 74 to an annular vacuum chamber 78. The annular orifice 74 faces towards the path of the polymeric material immediately as it issues from the extrusion orifice. The annular orifice, therefore, is positioned axially between the die orifice and the primary annular air outlet 29. The annular orifice 74 is an inlet orifice for removing contaminants, such as smoke, odorous fumes, and other airborne contaminants exiting the extrusion orifice as a result of the extrusion process.

The annular orifice 74 is connected by way of the passageway 76, through the vacuum chamber 78 and connecting vacuum tubes 80 to a vacuum creating means in the form of an electrically driven blower 82. Filters are provided as necessary throughout the air filtering device. In this embodiment, a filter may be provided, for instance, as an annular filter 84 within the passageway 76. This filter may be easily removable, for instance, by detaching the lower plate 72. A further filter 86 is shown downstream of the blower 82. Another filter or filters may be located in another location or locations, e.g. upstream of the blower 82.

The air filtering device may be secured directly to the air ring means, which may be air rings 10a, b, or c, as described in the above embodiments, or of any other suitable design. In use of the fourth embodiment, immediately contaminants issue from the die orifice on the outside of the tube thus formed, they are removed through the orifice 74 uniformly around the tube. The filters operate to extract contaminants which may be harmful to personnel or dangerous when accumulated on machinery or building surfaces that may become slippery or oily from the oil and air-borne by products. The air which has been cleared by the filters may then be discharged into the surrounding air within the factory if desired. Air may be cleaned instead by electrostatic precipitator.

It is also important to note that with the inlet orifice 74 positioned closely adjacent to the die orifice, a certain quantity of heat will immediately be removed from the tube as it exits the die orifice. The inlet orifice 74 in being close to the primary air outlet 29 provides a unique feature in that some of the cooling air from the outlet 29 is drawn by the orifice 74 upstream of the flow of the tubular bubble thereby providing an initial cooling effect upon the plastic as it emerges from the die orifice. Thus the cooling rate is improved by reducing the temperature of the polymeric material upstream of the outlet 29, hence enabling the air ring means 10c to operate with greater efficiecy so as to enable increase in production. The removal of the contaminants presents a healthier working environment and assists in retarding the accumulation of undesirable debris and contaminant surface coatings upon factory structures and machines.

In a first modification of the fourth embodiments (not shown) the vacuum chamber is pressurized with air along the tubes 80 to pass the pressurized air along the passageway 76. The annular orifice 74 is then an outlet orifice for the pressurized air which applies cooling to the polymeric material immediately as its emerges from the die orifice particularly for start up purposes of the equipment.

In a second modification (not shown) in which the orifice 74 is an outlet orifice as just described above, the orifice 74 becomes the primary air outlet. In this second modification the air outlet 29 becomes an inlet orifice for removing contaminants exiting the extrusion orifice. The inlet orifice 29 is connected to its own vacuum chamber, blower and filters as described for the annular orifice 74 of the fourth embodiment. Hence, to retain the secondary air outlet 32 operating as described above, the vacuum arrangement for the orifice 29 must be, in this second modification, completely separate from the pressurized system including the air plenum chamber and the outlet orifice 32.

1. Air ring means for supplying successive streams of cooling air to the exterior surface of a tubular bubble of plastic, after its extrusion from an annular die orifice, having a die axis, the air ring means comprising:
a ring shaped plenum chamber provided radially outwardly of the die axis from the annular die orifice and having air inlet means;
annular cooling air outlet means to allow the tubular bubble to expand coaxially from the die at an angle of divergence from the die axis, the annular cooling outlet means comprising an annular cooling air outlet disposed radially outwardly of and adjacent the die orifice and directed towards the path of the tubular bubble;
air flow passages means interconnecting the plenum chamber to the annular cooling air outlet means for air flow;
air flow control means rotatably adjustable in position around the die axis, the air flow control means having a plurality of ports to air flow passage means associated with the cooling air outlet, rotational adjustment of the air flow control means in a desired direction causing movement of the ports relative of the air flow passage means so as to appropriately adjust the effective area for cooling air flow through the passage means and from the annular air outlet; and
means to adjust the rotational position of the air flow control means, the adjustment means operably connected to the air flow control means and being operably accessible externally of the air ring means.

2. Air ring means according to claim 1, wherein the annular cooling air outlet is a primary air outlet and the annular cooling air outlet means also comprises a secondary annular air outlet downstream in the direction of movement of the tubular bubble, from the primary air outlet, and the air flow control means is rotatably adjustable to adjust the rate of air flow only from the primary air outlet.

3. Air ring means according to claim 2, wherein the air flow passage means to the primary air outlet is first air flow passage means and second air flow passage means is provided from the plenum chamber to the secondary air outlet with the first air flow passage means disposed axially of the die axis from the second air passage means, and the air flow control means is also provided with ports for the second air flow passage means, the relationship of the second air flow passage means ans their respective ports ensuring that rotational adjustment of the air flow control means insignificantly affects the rate of air flow through the second air flow passage means.

4. Air ring means according to claim 1, wherein the air flow control means is located radially outwards relative to the die axis from the air flow passage means.

5. Air ring means according to claim 1, wherein the air flow control means comprises a ring formed with the air flow ports, the ring being rotatable around the die axis.

6. Air ring means according to claim 5, wherein the adjustment means comprises a manually operable driving gear rotatably mounted about a fixed axis, the driving gear driveably in mesh with a driven gear provided upon the ring.

7. Air ring means according to claim 6, wherein the adjustment means comprises a rotatable shaft carried by a wall of the air ring means, the shaft having an end extending exteriorly of the wall for operation purposes and another p art of the shaft carries the driving gear fixedly upon the shaft whereby rotation of the shaft rotates the driving gear to rotatably adjust the position of the ring.

8. Air ring means according to claim 7, wherein the exterior end of the shaft is provided with indicator means to indicate, at any particular position of rotation of the shaft, the amount of effective area available for air flow through the air flow passage means to the annular cooling air outlet.

9. Air ring means according to claim 2, wherein the primary and secondary annular air outlets are constructed and relatively disposed to allow the extruded tubular bubble to expand coaxially relative to the die axis at an angle of divergence of at least 45 degrees from the die axis.

10. Apparatus for extruding a tubular bubble of plastic comprising;
a plastic extruder having an annular die orifice surrounding a die axis;
air ring means for supplying cooling air to the exterior surface of the tubular bubble of plastic after its extrusion from the die orifice, the air ring means comprising:
a ring shaped plenum chamber radially outwards from the die axis and from the annular die orifice and having cooling air inlet
means; and
annular cooling air outlet means interconnected to the plenum chamber closely adjacent to the die orifice to cause the tubular bubble to expand radially in coaxial manner relative to the die axis as it moves downstream from the die orifice; and
an air filtering device, and the air filtering device providing an annular air inlet orifice disposed axially between the die orifice and the annular cooling air outlet means so as to face towards the exterior of the tubular bubble as it is being formed, the inlet orifice interconnectable to vacuum creating means for removing contaminants from the exterior of the tubular bubble.

11. Apparatus according to claim 10, wherein the air filtering device comprises an annular vacuum chamber passage means interconnecting the inlet orifice and the vacuum chamber.

12. Apparatus according to claim 11, wherein the vacuum passage means comprises an annular disc-shaped passage.

13. Apparatus according to claim 11, wherein air filter means is provided in the vacuum passage means.

14. Apparatus according to claim 10, wherein the annular air inlet orifice is sufficiently close to the annular cooling air outlet means to draw some cooling air, as it issues from the outlet means, in an upstream direction relative to the direction to movement of the tubular bubble from the die orifice, the cooling air then passing into the inlet orifice together with contaminants.

15. Air ring means for supplying successive streams of cooling air to the exterior surface of a tubular bubble of plastic after its extrusion from an annular die orifice having a die axis, the air ring means comprising:
a ring shaped plenum chamber surrounding the annular die orifice and having inlet means;
a primary annular air outlet arranged to be located around and closely adjacent the die orifice and communicating with the plenum chamber;
a secondary annular air outlet located axially downstream of the primary annular air outlet in the direction of travel of the tubular bubble and also communicating with the plenum chamber;
the primary annular air outlet being formed between inner lip means and an edge of an intermediate lip means adjacent the inner lip means, and the secondary annular air outlet being formed between inner lip means and an edge of an intermediate lip means adjacent the inner lip means, and the secondary annular air outlet being formed between an outer lip means and an edge of the intermediate lip means adjacent the outer lip means;
wherein the inner lip means, the intermediate lip means and the outer lip means are arranged to diverge from the die so as to allow the tubular bubble to expand coaxially from the die at an angle of divergence of approximately 60 degrees from the die axis without interfering with any of the lip means.

16. Air ring means according to claim 15, wherein the intermediate lip means has a substantially conical inner surface which diverges from the inner lip means at an angle at least as great as the angle of divergence.

17. Air ring means according to claim 15 or claim 16, wherein the cross-sectional area of the secondary air outlet is several times greater that the cross-sectional area of the primary air outlet.

18. Air ring means according to claim 15, wherein the primary air outlet is caused to direct air partially downstream of the direction of travel of the bubble by the inner lip means having an outwardly sloping outer surface.

19. Air ring means according to claim 15, wherein means are provided to cause rotation of air leaving the air outlets.
